(19) United States
(12) Patent Application Publication
(10) Pub. No.: US 2025/0124586 A1
(43) Pub. Date: Apr. 17, 2025

(54) PARALLAX INFORMATION GENERATION DEVICE AND PARALLAX INFORMATION GENERATION METHOD

(71) Applicant: Panasonic Intellectual Property Management Co., Ltd., Osaka (JP)

(72) Inventors: Hiromu KITAJIMA, HYOGO KEN (JP); Toru OKINO, OSAKA FU (JP); Yusuke YUASA, KYOTO FU (JP); Shigeru SAITOU, KYOTO FU (JP)

(21) Appl. No.: 18/834,919

(22) PCT Filed: Mar. 23, 2023
(86) PCT No.: PCT/JP2023/011581

§ 371 Date: Jul. 31, 2024

(30) Foreign Application Priority Data
Mar. 30, 2022 (JP) 2022-057322

(51) Int. Cl. G06T 7/521; G06T 7/11; G06T 7/136; G06T 7/55

(52) U.S. Cl. CPC G06T 7/521; G06T 7/11; G06T 7/136; G06T 7/55; G06T 2207/10152

(57) ABSTRACT

A parallax information generation device includes: a phase image generation unit that generates a relative phase image from phase shift images based on projection of phase shift pattern light; a code image segmentation processing unit that performs segmentation for each period of the phase shift pattern light on the basis of a sequence generated from a code value given to each pixel of binary pattern images based on projection of binary pattern light; and a parallax information generation unit that generates parallax information on the basis of the relative phase image and results of the segmentation. The binary pattern light is constituted by a sequence in which 2n mutually different code values are allocated by combining n kinds of binary pattern light, and mutually different code values are allocated at each boundary between periods of the phase shift pattern light.

### BACKGROUND

The present disclosure relates to a parallax information generation device and a parallax information generation method.

As a three-dimensional measuring technique, a phase shift method is known in which a spatially intensity-modulated sine wave pattern is projected and a phase value in a spatial domain is calculated for each pixel.

For example, Japanese Patent No. 6334861 (Patent Document 1) describes a visual inspection device in which a phase shift image subjected to projection based on the phase shift method by a projection control means and captured by an imaging means is processed, also a spatial code image subjected to projection based on a spatial coding method by the projection control means and captured by the imaging means is processed, and the processed results of the phase shift image and the special code image are combined to generate a distance image.

Also, to eliminate ambiguity of phase values in the phase shift method, a spatial code pattern (Gray code) is additionally projected in some cases.

For example, Japanese Unexamined Patent Publication No. 2020-41822 (Patent Document 2) describes a three-dimensional measuring system in which a Gray code pattern image and a phase shift pattern image are projected onto the measurement object by a projection unit, an image of the measurement object with the Gray code pattern image projected thereon and an image of the measurement object with the phase shift pattern image projected thereon are captured by an imaging unit, and parallax image data and point-cloud data representing a three-dimensional shape are generated based on the captured image data.

In the phase shift method, in order to improve the measuring precision, measurement using a sine wave pattern having a high spatial frequency is necessary.

However, in a technique using time-series code, like the one described in Patent Document 2, the number of spatial code patterns additionally projected increases with increase in spatial frequency, causing a problem of prolonging the calculating time of one frame.

In view of the above problem, an objective of the present disclosure is providing a parallax information generation device in which the calculation time of one frame is shortened compared with the conventional technique using time-series code.

### SUMMARY

According to one mode of the present disclosure, a parallax information generation device includes: a projection unit that projects a plurality of kinds of phase shift pattern light having periodicity and n (n is an integer equal to or greater than 2) kinds of binary pattern light onto a measurement object; an imaging unit that captures an image of the measurement object; a phase image generation unit that generates a relative phase image from a plurality of phase shift images, the phase shift images being images, captured by the imaging unit, of the measurement object with the plurality of kinds of phase shift pattern light respectively projected onto the measurement object; a code image segmentation processing unit that gives a code value to each pixel of n binary pattern images, the binary pattern images being images, captured by the imaging unit, of the measurement object with the n kinds of binary pattern light respectively projected onto the measurement object, and performs segmentation for each period of the phase shift pattern light based on a sequence generated from the code values; and a parallax information generation unit that generates parallax information based on the relative phase image and results of the segmentation, wherein the binary pattern light projected from the projection unit is configured to form a sequence in which 2n mutually different code values are allocated to each period of the phase shift pattern light by combining the n kinds of binary pattern light, and different code values are allocated at each boundary between periods of the phase shift pattern light.

According to the present disclosure, since the period number of a sine wave pattern can be estimated from a smaller number of projected patterns than in the conventional technique using time-series code, the calculation time of one frame is shortened, whereby speedup of the processing can be achieved.

### BRIEF DESCRIPTION OF THE DRAWINGS

FIG. 1 schematically shows how pattern light is projected onto a measurement object and imaging is performed.

FIG. 2 is a block diagram showing a configuration example of a parallax information generation device.

FIG. 3 shows an example of binary pattern light and a segmentation processing flow.

FIG. 4 is a view showing the number of kinds of binary pattern light when the period number is 24 or less.

FIG. 5 is a flowchart showing an operation example of the parallax information generation device.

FIG. 6 illustrates conversion of a captured image into a binarized image.

FIG. 7 is a view illustrating an alteration of the embodiment.

FIG. 8 is a view illustrating another alteration of the embodiment.

### DETAILED DESCRIPTION

An embodiment of the present disclosure will be described hereinafter in detail with reference to the accompanying drawings. Note that description of the embodiment to follow is essentially a mere illustration and by no means intended to restrict the present invention, applications thereof, or uses thereof. That is, numerical values, shapes, components, disposed positions and connecting styles of the components, and the like shown in the embodiment below are examples and by no means purport to limit the present disclosure. Therefore, among components in the embodiment below, a component that is not described in an independent claim representing a highest concept of the present disclosure will be described as an optional component.

A parallax information generation device according to the present disclosure uses the phase shift method. As described above, in the phase shift method, spatially intensity-modulated sine wave pattern light is projected and a phase value in a spatial domain is calculated for each pixel.

The parallax information generation device according to the present disclosure is characterized in that the number of spatial code patterns (Gray code) projected to eliminate ambiguity of phase values in the phase shift method can be made smaller than in the conventional technique. This shortens the calculation time of one frame, whereby speedup of the processing can be achieved, as described above.

Hereinafter, for easy understanding of the disclosure, the phase shift method will be first summarized, and then the specific configuration and operation of a parallax information generation device 1 will be described.

### <Phase Shift Method>

The phase shift method is a three-dimensional measuring technique in which a plurality of kinds of phase shift pattern light that are spatially intensity-modulated and have periodicity are projected onto a measurement object, and a phase value in a spatial domain is calculated for each pixel.

As phase shift pattern light Q0 having periodicity, a sine wave pattern is projected with its phase shifted by π/2 each, for example. Specifically, a total of four times (l=1, 2, 3, 4) of measurement is performed in Expression (1):

$${I}_{l} ( x ) = A ( x ) cos ( {ϕ}_{s} ( x ) - \frac{π l}{2} ) + O ( x ) \qquad ( 1 )$$

where A(x) is the amplitude of the sine wave pattern, ϕs(x) is the phase value of the sine wave pattern, and O(x) is the light amount of environment light.

From the measured values l0-l3, ϕs(x) is calculated using Expression (2) below.

$${ϕ}_{s} ( x ) = {tan}^{- 1} ( \frac{{I}_{3} ( x ) - {I}_{1} ( x )}{{I}_{0} ( x ) - {I}_{2} ( x )} ) \qquad ( 2 )$$

Further, using Expression (3) below, the distance d (x) can be calculated by triangulation from the phase value ϕs(x) calculated by Expression (2) above.

$$d ( x ) = \frac{b \times f}{x - \frac{{ϕ}_{s} ( x )}{{ω}_{s}}} \qquad ( 3 )$$

where b is the base line length between a projection unit 2 and an imaging unit 3, f is the focal distance, and ωs is the spatial frequency. Also, the denominator on the right side of Expression (3) indicates the parallax value.

As described above, in the phase shift method, the phase difference (relative value) is repeated with a period of 2π. Therefore, by determining the period number (region number) k of phase values, the ambiguity of the phase values can be eliminated, and the parallax D can be determined from the absolute phase ϕ′ represented by Expression (4) below using Expression (5) below. In other words, how much the value of each pixel is displaced is expressed by the relative value, and the absolute phase value can be determined using the region number k.

$${ϕ}^{′} = {ϕ}_{s} + 2 π k \qquad ( 4 )$$

$$D = x - \frac{{ϕ}^{′} ( x )}{{ω}_{s}} \qquad ( 5 )$$

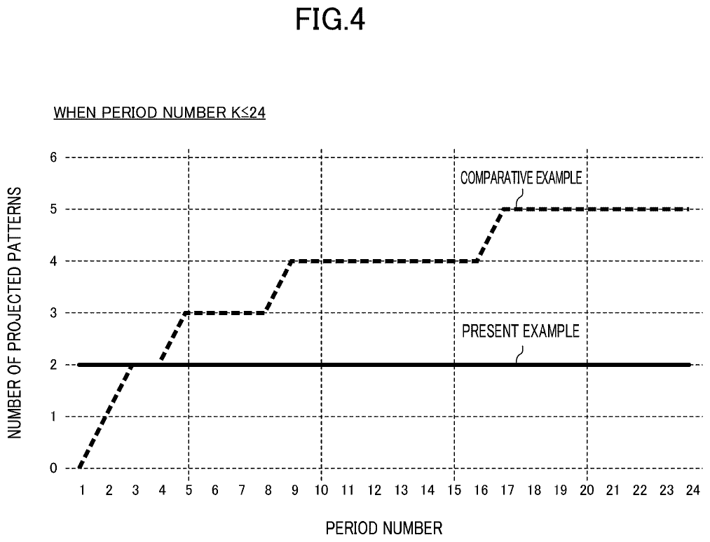

As a technique for specifying the region number k, there is a method of additionally projecting a Gray code pattern. In the conventionally known Gray code method, as shown in Patent Document 2, for example, a time-series black-and-white pattern is projected onto a measurement object, and processing of associating camera pixels with region numbers k is executed. As described above, in the conventional technique, when the period number of the sine wave pattern projected is K, it is necessary to project “log 2K” Gray code patterns. This raises the problem that the number of patterns projected increases with increase in period number K (see a comparative example in FIG. 4). In contrast to this, the parallax information generation device 1 according to the present disclosure is characterized in that the period number of the sine wave pattern can be estimated from a smaller number of projected patterns than in the conventional technique using time-series code.

Hereinafter, the present disclosure will be described specifically presenting a configuration example of the parallax information generation device 1.

### <Parallax Information Generation Device>

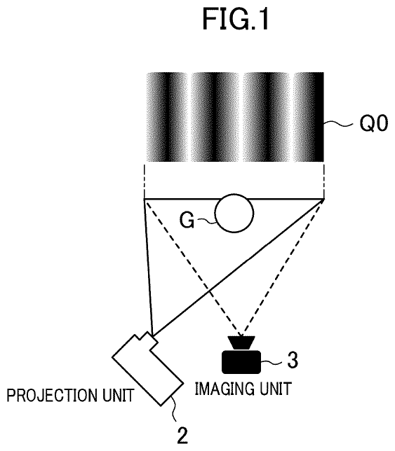

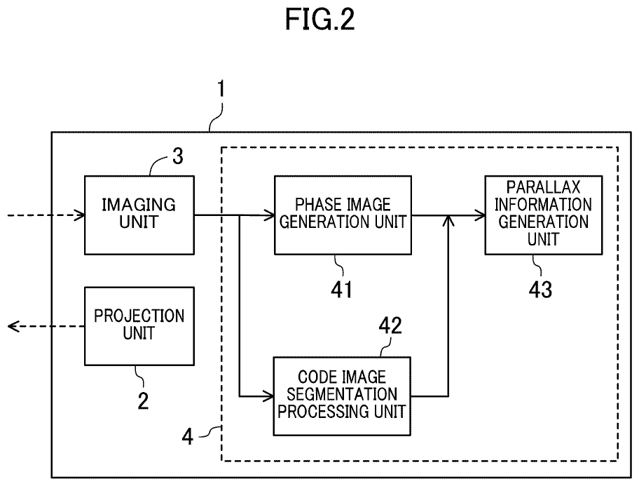

FIG. 1 is a schematic view showing a placement example of the projection unit 2 that projects pattern light onto a measurement object G and the imaging unit 3 that captures an image of the measurement object G. FIG. 2 is a block diagram showing a configuration example of the parallax information generation device 1.

As shown in FIG. 2, the parallax information generation device 1 includes the projection unit 2, the imaging unit 3, and a computation unit 4. The computation unit 4 includes a phase image generation unit 41, a code image segmentation processing unit 42, and a parallax information generation unit 43.

### —Projection Unit—

The projection unit 2 projects a plurality of kinds of the phase shift pattern light Q0 having periodicity and n (n is an integer equal to or greater than 2) kinds of binary pattern light PT onto the measurement object G. The projection unit 2 can be implemented by a projection scheme of a general projector and can use a device such as a digital micromirror device (DMD), a liquid crystal display (LCD), and a liquid crystal on silicon (LCOS).

For example, when the period number K is 24, the projection unit 2 projects, as projection patterns, four kinds of phase shift pattern light, two kinds of binary pattern light PT, and one kind of full-light pattern light onto the measurement object G. The imaging unit 3 acquires, at the time of light exposure, four phase shift pattern images, two binary pattern images, one full-light pattern image, and one environment light image. The projection unit 2 projects these images while sequentially switching the respective kinds of pattern light from one to another at the time of projection and at the time of light exposure. The full-light pattern image is an image obtained by turning on the projection unit 2 to illuminate the entire measurement object G with the same quantity of light. The environment light is light obtained when the projection unit 2 is turned off. That is, the environment light image is an image exposed to light when the projection unit 2 is off.

The phase shift pattern light is projected by shifting the phase of a sine wave pattern by π/2 each and sequentially switching the phase-shifted patterns from one to another, as described above.

The binary pattern light is pattern light for phase unwrapping, and configured so that, by combining n (n is an integer equal to or greater than 2) binary patterns, formed is a sequence in which 2n mutually different code values are allocated to each period T of the phase shift pattern light. For convenience in description, each period T is regarded as one region, and such regions are numbered kx (x=0, 1, 2, . . . ).

For example, the binary pattern light is configured to form a sequence in which, when n binary patterns are mutually aligned and superimposed, 2n mutually different code values are allocated to each period T of the phase shift pattern light.

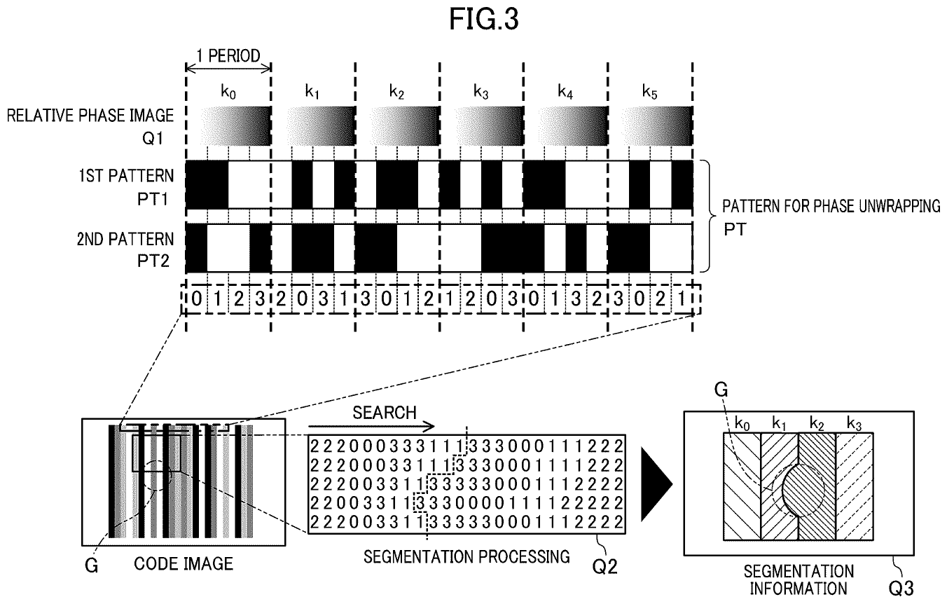

FIG. 3 shows an example in which the binary pattern light PT is constituted by two patterns, a first pattern PT1 and a second pattern PT2. For example, code value “0” is given to a position where PT1=black and PT2=black, code value “1” to a position where PT1=black and PT2=white, code value “2” to a position where PT1=white and PT2=white, and code value “3” to a position where PT1=white and PT2=black. As a result, in the example of FIG. 3, four mutually different code values, “0123”, are allocated to region k0. Similarly, four mutually different code values are allocated to each region k, such as “2031” to region k1, “3012” to region k2, and “1203” to region k3. As used herein, the code block constituted by four mutually different code values is called a “code string” in some cases. Note that a plurality of pixels may be included in one digit of code (see Q2 in FIG. 3).

Also, the binary pattern light is configured so that mutually different code values are allocated at each boundary in the phase shift pattern light Q0 (a relative phase image Q1), i.e., at each boundary between the regions k (between the code strings). For example, in the example of FIG. 3, the mutually different code values, “3-2”, are allocated at the boundary between region k0 and region k1. Similarly, mutually different code values are allocated at the boundaries, such as “1-3” at the boundary between region k1 and region k2, “2-1” at the boundary between region k2 and region k3, and “3-0” at the boundary between region k3 and region k4.

Also, mutually different code strings are preferably allocated to all regions. For example, when the period number K of the phase shift pattern light Q0 (hereinafter simply called the period number K) is 24, it is preferable to allocate mutually different code strings to 24 regions k.

FIG. 4 shows the number of kinds of the binary pattern light PT when the period number K is 24 or less. In FIG. 4, the example of this embodiment is indicated by the solid line, and a comparative example using time-series code is indicated by the broken line. As shown in FIG. 4, in the comparative example, the number of kinds of the binary pattern light PT projected increases with increase in period number K. On the other hand, the number of kinds of the binary pattern light PT projected in this embodiment is only two in the range of the period number K≤24.

Specifically, the period number K of the phase shift pattern light Q0 and the number of kinds n of the binary pattern light PT satisfy Expression (6) below.

$$K \leq 2 \hat{} n ! \qquad ( 6 )$$

### —Imaging Unit—

The imaging unit 3 is a unit capturing an image of the measurement object G, which is a camera, for example.

When a plurality of kinds of the phase shift pattern light Q0 are sequentially switched from one to another and projected onto the measurement object G from the projection unit 2 at the time of imaging and at the time of light exposure, the imaging unit 3 captures images of the measurement object G with the respective kinds of the phase shift pattern light Q0 projected thereon, and outputs the resultant images to the phase image generation unit 41 as phase shift images. For example, when four kinds of the phase shift pattern light Q0 with its phase shifted by π/2 each are projected from the projection unit 2, the imaging unit 3 outputs four phase shift images corresponding to the four kinds of the phase shift pattern light Q0 to the phase image generation unit 41.

Also, the imaging unit 3 captures images of the measurement object G with the binary pattern light PT projected thereon and outputs the resultant images to the code image segmentation processing unit 42 as binary pattern images. Specifically, when n kinds of the binary pattern light PT are sequentially switched from one to another and projected onto the measurement object G from the projection unit 2, the imaging unit 3 captures images of the measurement object G with the respective kinds of the binary pattern light PT projected thereon, and outputs the resultant images to the code image segmentation processing unit 42 as binary pattern images. For example, when two kinds of binary pattern light, PT1 and PT2, are projected from the projection unit 2, the imaging unit 3 outputs two binary pattern images corresponding to the two kinds of binary pattern light, PT1 and PT2, to the code image segmentation processing unit 42.

### —Computation Unit—

The computation unit 4 is constituted by a CPU (processor) and a memory for storing programs for operating the CPU and processed results by the CPU, for example. That is, the computation unit 4 includes programs for implementing the functions of the phase image generation unit 41, the code image segmentation processing unit 42, and the parallax information generation unit 43. Note that part or all of the functions of the phase image generation unit 41, the code image segmentation processing unit 42, and the parallax information generation unit 43 may be implemented by hardware circuits and the like.

### [Phase Image Generation Unit]

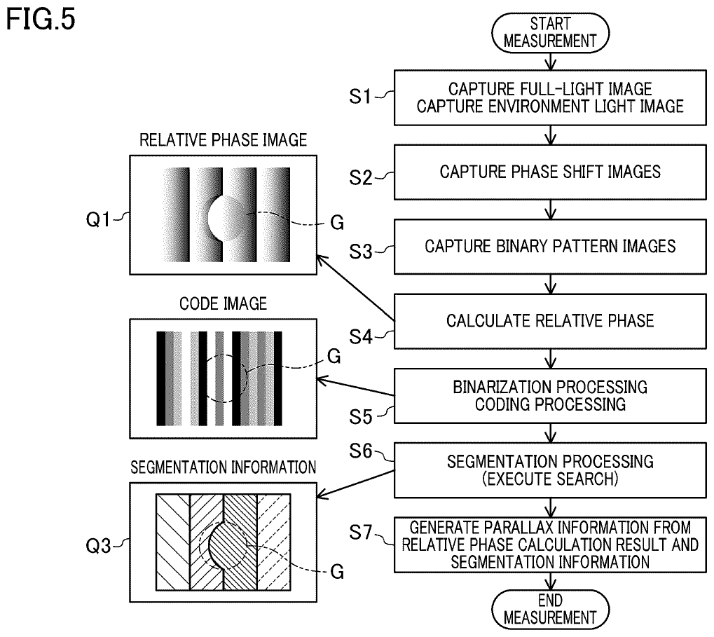

The phase image generation unit 41 generates a phase image based on the plurality of phase shift images captured by the imaging unit 3. For example, when four phase shift images are output from the imaging unit 3 as described above, the phase image generation unit 41 generates a relative phase image Q1 (see FIG. 5) based on the four phase shift images.

### [Code Image Segmentation Processing Unit]

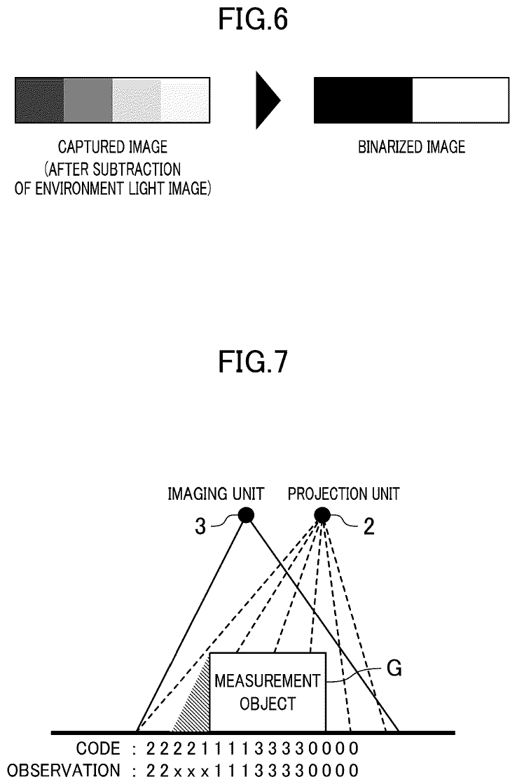

The code image segmentation processing unit 42 gives a code value to each pixel of the n binary pattern images captured by the imaging unit 3. Specifically, as shown in FIG. 6, the environment light image captured under the environment light is subtracted from the binary pattern images, and the subtracted results are converted to binarized images. A binarized image PR1 from the binary pattern image captured when the first pattern PT1 is projected and a binarized image PR2 from the binary pattern image captured when the second pattern PT2 is projected are combined, and code values are given to the combined image. The rule of giving code values is the same as that for the projection patterns in the projection unit 2 described above: e.g., code value “0” is given to a pixel where PR1=black and PR2=black, code value “1” to a pixel where PR1=black and PR2=white, code value “2” to a pixel where PR1=white and PR2=white, and code value “3” to a pixel where PR1=white and PR2=black. As a result, an image of sequences (code image) as shown in FIGS. 3 and 5 is obtained. In other words, unique sequences constituted by code values are obtained. Note that, although specific illustration is omitted, in the code image, also, as in the relative phase image Q1, the image is deformed into an arc shape in the region in which the measurement object G is imaged.

Thereafter, the code image segmentation processing unit 42 executes segmentation processing of performing segmentation based on the sequences generated from the given code values. Specifically, as shown in Q2 in FIG. 3, a boundary between regions k is searched for from the sequences constituting the lines. As a result, the boundary between region k1 and region k2, for example, is recognized at the position shown by the broken line in Q2 in FIG. 3.

### [Parallax Information Generation Unit]

The parallax information generation unit 43 generates parallax information based on the phase image generated in the phase image generation unit 41 and the results of the segmentation (hereinafter referred to as segmentation information Q3) obtained in the code image segmentation processing unit 42. FIG. 3 shows an example of the segmentation information Q3.

The parallax information generated in the parallax information generation unit 43 is used for distance calculation by triangulation. The computational expressions for determining the parallax are exemplified in the <Phase Shift Method> described above.

### <Operation of Parallax Information Generation Device>

The operation of the parallax information generation device 1 will be described using the flowchart of FIG. 5.

### —Step S1—

In step S1, full-light pattern light is projected onto the measurement object G from the projection unit 2, and in this state, an image of the measurement object G is captured using the imaging unit 3, to acquire a full-light image. Also, an image of the measurement object G is captured under the environment light using the imaging unit 3, to acquire an environment light image. The full-light image and the environment light image are output to the code image segmentation processing unit 42 for use in binarizing processing and the like.

### —Step S2—

In step S2, a plurality of kinds of phase shift pattern light having periodicity are projected onto the measurement object G from the projection unit 2, and images in the projected state are captured by the imaging unit 3, to acquire the above-described phase shift images. For example, the projection unit 2 projects four kinds of the phase shift pattern light Q0 with its phase shifted by π/2 each onto the measurement object G while sequentially switching them from one to another. The imaging unit 3 captures four phase shift images corresponding to the four kinds of the phase shift pattern light Q0 and outputs the images to the phase image generation unit 41.

### —Step S3—

In step S3, n kinds of binary pattern light are projected onto the measurement object G from the projection unit 2, and images in the projected state are captured by the imaging unit 3, to acquire the above-described binary pattern images. For example, the projection unit 2 projects two kinds of the binary pattern light PT (first pattern PT1 and second pattern PT2) onto the measurement object G while sequentially switching them from one to the other. The imaging unit 3 captures two binary pattern images corresponding to the two kinds of the binary pattern light PT and outputs the images to the code image segmentation processing unit 42.

### —Step S4—

In step S4, the phase image generation unit 41 executes relative phase calculation based on a plurality of phase shift images captured by the imaging unit 3. Specifically, the relative phase image Q1 is generated based on the four phase shift images, for example. In other words, the phase image generation unit 41 executes the processing of generating the relative phase image Q1 based on a plurality of phase shift images that are images captured by the imaging unit 3 at the time when a plurality of kinds of the phase shift pattern light Q0 are sequentially switched from one to another by the projection unit 2.

### —Step S5—

In step S5, the code image segmentation processing unit 42 executes binarizing processing and coding processing. Specifically, the environment light image is subtracted from the binary pattern images, the subtracted results are converted to binarized images, and a code value is given to each pixel, to generate a code image. The way of giving the code value is as described above.

No concrete method for the binarizing processing is specified. As an example, however, a threshold may be set from the average of the two images, the full-light image and the environment light image.

### —Step S6—

In step S6, the code image segmentation processing unit 42 executes segmentation processing of performing segmentation based on sequences generated from the given code values. By this segmentation processing, the segmentation information Q3 is generated. Specifically, the segmentation processing described above is executed. Note that the code image segmentation processing unit 42 may extract edge information from the environment light image for use in correction at the time of segmentation.

In other words, in steps S5 and S6, the code image segmentation processing unit 42 executes the following processing: a code value is given to each pixel of n binary pattern images that are images, captured by the imaging unit 3, of the measurement object G with n kinds of the binary pattern light PT projected thereon from the projection unit 2, and segmentation is performed for each period of the phase shift pattern light Q0 based on the sequences generated from the code values. The processing of steps S5 and S6 corresponds to the code image segmentation processing.

Note that the processing of step S4 and the processing of step S5 and/or step S6 can be executed in parallel. By executing such multiple processing, speedup of processing can be achieved.

### —Step S7—

In step S7, parallax information is generated based on the relative phase image Q1 generated in step S4 and the results of segmentation (segmentation information Q3) in step S6. The processing of step S7 corresponds to the parallax information generation processing.

As described above, according to this embodiment, the binary pattern light projected from the projection unit 2 is configured so that, by combining n binary patterns, formed is a sequence in which 2n mutually different code values are allocated to each period of the phase shift pattern light Q0. Also, mutually different code values are allocated at each boundary between periods of the phase shift pattern light Q0.

Therefore, since the period number of the sine wave pattern can be estimated from a smaller number of projected patterns than in the conventional technique using time-series code, the calculation time of one frame is shortened, whereby speedup of the processing can be achieved.

### Other Embodiments

The present disclosure is not limited to the embodiment described above, but various modifications may be made without departing from the spirit of the disclosure.

For example, the code image segmentation processing unit 42 may presume a region in which the difference between the brightness value of the above-described binary pattern images and the brightness value of the above-described environment light image is a predetermined value or less to be a shadow region, and exclude pixels included in the shadow region from the search target for the boundary in the segmentation processing.

FIG. 7 is a view illustrating an alteration of the embodiment. In the example of FIG. 7, a region onto which pattern light output from the projection unit 2 is not projected (hereinafter referred to as the shadow region) is formed in a portion on a side of the measurement object G (see the hatched portion in FIG. 7). In the shadow region, the binary pattern light PT output from the projection unit 2 is supposed unable to be observed. Also, the shadow region can be said to be a region in which the observed brightness value does not change since it receives no projection light at the time of projection of pattern light from the projection unit 2. In consideration of this, the code image segmentation processing unit 42 may presume a region in which the difference between the brightness value of the binary pattern images and the brightness value of the environment light image is a predetermined value or less to be the shadow region, and exclude the shadow region at the search in the segmentation processing.

In the example of FIG. 7, how the binary pattern light PT illuminates the row marked as “code” is indicated by codes, and code values based on the binary pattern images are shown in the row marked as “observation”. Also, the region indicated by “x” is presumed to be the shadow region. In this example, in the segmentation processing, the region indicated by “x” is excluded from the search target. In this way, the processing can be sped up.

In the segmentation processing, for example, the code image segmentation processing unit 42 may (1) presume a shield region of the binary pattern images based on the sequence data of the binary pattern light PT, and (2) determine the boundary for segmentation in the shield region based on edge information of the measurement object G in the binary pattern images. The shield region is a region to be imaged but shielded by the measurement object G.

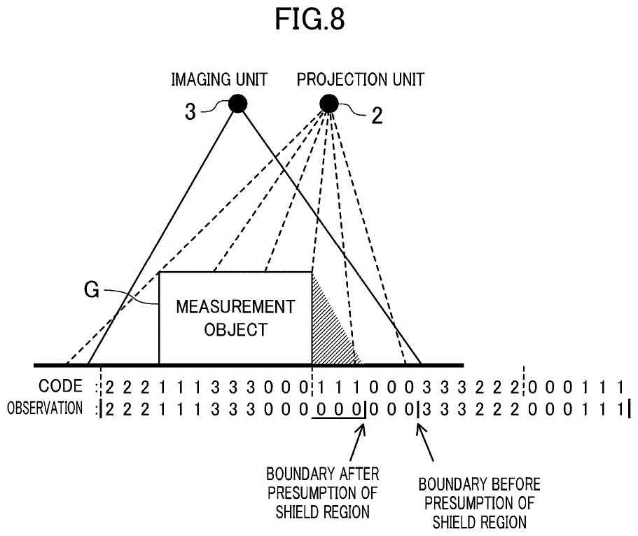

For example, in the example of FIG. 8, as in FIG. 7, how the binary pattern light PT illuminates the row marked as “code” is indicated by codes, and code values based on the binary pattern images are shown in the row marked as “observation”. The portion underlined in the “observation” row is the shield region. As shown in FIG. 8, in this example, there is a possibility that the observed boundary position recognized in the segmentation processing may be displaced from the real boundary position (indicated as the “boundary before presumption of shield region” in FIG. 8).

In consideration of the above, the code image segmentation processing unit 42 presumes the shield region caused by the measurement object G in the binary pattern images based on the sequence data of the binary patterns used in the binary pattern light PT. Specifically, in the example of FIG. 8, since the sequence of the binary patterns projected from the projection unit 2 is “2130103201”, it is found that “1” between the fourth code “0” and the sixth code “0” from the left is missing. In this way, the code image segmentation processing unit 42 presumes that there may be a shield region between the fourth code “0” and the sixth code “0” from the left in the observation codes. Then, when having found a sequence different from the proper sequence, the code image segmentation processing unit 42 determines the boundary based on edge information and restarts the search in the segmentation processing. Note that, in FIG. 8, the boundary after the presumption of the shield region is indicated as the “boundary after presumption of shield region.”

Thereafter, the code image segmentation processing unit 42 may determine the boundary for segmentation in the shield region based on edge information of the measurement object G and the entire scene acquired from the environment light image. The method of detecting edge information of the measurement object G is not specifically limited, but a conventionally known method can be used. In this way, segmentation (search) processing can be executed while reducing displacement due to the formation of a shield region to a minimum.

The parallax information generation device according to the present disclosure is significantly useful because the calculation time of one frame is shortened whereby speedup of the processing can be achieved.

1. A parallax information generation device, comprising:
a projection unit that projects a plurality of kinds of phase shift pattern light having periodicity and n (n is an integer equal to or greater than 2) kinds of binary pattern light onto a measurement object;
an imaging unit that captures an image of the measurement object;
a phase image generation unit that generates a relative phase image from a plurality of phase shift images, the phase shift images being images, captured by the imaging unit, of the measurement object with the plurality of kinds of phase shift pattern light respectively projected onto the measurement object;
a code image segmentation processing unit that gives a code value to each pixel of n binary pattern images, the binary pattern images being images, captured by the imaging unit, of the measurement object with the n kinds of binary pattern light respectively projected onto the measurement object, and performs segmentation for each period of the phase shift pattern light based on a sequence generated from the code values; and
a parallax information generation unit that generates parallax information based on the relative phase image and results of the segmentation,
wherein
the binary pattern light projected from the projection unit is configured to form a sequence in which 2n mutually different code values are allocated to each period of the phase shift pattern light by combining the n kinds of binary pattern light, and different code values are allocated at each boundary between periods of the phase shift pattern light.

2. The parallax information generation device of claim 1, wherein
the period number K of the phase shift pattern light and the number of kinds n of binary pattern light satisfy the following relational expression.
$$K \leq 2 \hat{} n !$$

3. The parallax information generation device of claim 1, wherein
the code image segmentation processing unit presumes a region in which a difference between a brightness value of the binary pattern images and a brightness value of an environment light image captured by the imaging unit under environment light is equal to or less than a predetermined threshold to be a shadow region, and excludes a pixel included in the shadow region from a search target for a boundary in the segmentation.

4. The parallax information generation device of claim 1, wherein
the code image segmentation processing unit presumes a shield region, which is a region to be imaged but shielded by the measurement object in the binary pattern images, based on the binary pattern light in the segmentation, and determines a boundary for the segmentation in the shield region based on edge information of the measurement object.

5. A parallax information generation method, comprising:
first step of capturing images, using an imaging unit, of a measurement object with a plurality of kinds of phase shift pattern light respectively projected onto the measurement object from a projection unit, and, in a computation unit, generating a relative phase image from a plurality of phase shift images that are the captured images;
second step of capturing images, using the imaging unit, of the measurement object with n (n is an integer equal to or greater than 2) kinds of binary pattern light respectively projected onto the measurement object from the projection unit, and, in the computation unit, giving a code value to each pixel of n binary pattern images that are the captured images and performing segmentation based on a sequence generated from the code values; and
third step of generating parallax information based on the relative phase image and results of the segmentation in the computation unit,
wherein
the binary pattern light projected from the projection unit is configured to form a sequence in which 2n mutually different code values are allocated to each period of the phase shift pattern light by combining n binary patterns, and different code values are allocated at each boundary between periods of the phase shift pattern light.

6. The parallax information generation method of claim 5, wherein
the processing of generating the relative phase image from the plurality of phase shift images in the first step and the processing of giving a code value to each pixel of the n binary pattern images and performing segmentation based on a sequence generated from the code values in the second step are executed in parallel.

7. The parallax information generation device of claim 2, wherein
the code image segmentation processing unit presumes a shield region, which is a region to be imaged but shielded by the measurement object in the binary pattern images, based on the binary pattern light in the segmentation, and determines a boundary for the segmentation in the shield region based on edge information of the measurement object.

8. The parallax information generation device of claim 3, wherein
the code image segmentation processing unit presumes a shield region, which is a region to be imaged but shielded by the measurement object in the binary pattern images, based on the binary pattern light in the segmentation, and determines a boundary for the segmentation in the shield region based on edge information of the measurement object.
